(19) United States
(12) Patent Application Publication
(10) Pub. No.: US 2023/0400049 A1
(43) Pub. Date: Dec. 14, 2023

(54) ROTATING CLINCHING CLASP

(71) Applicant: Ewing-Foley, Inc., Cupertino, CA (US)

(72) Inventor: Michael J. Maloney, Doylestown, PA (US)

(73) Assignee: Ewing-Foley, Inc., Cupertino, CA (US)

(21) Appl. No.: 18/084,702

(22) Filed: Dec. 20, 2022

Related U.S. Application Data
(60) Provisional application No. 63/350,570, filed on Jun. 9, 2022.

(51) Int. Cl. F16B 21/02

(52) U.S. Cl. CPC F16B 21/02

(57) ABSTRACT

A rotating clinching clasp is shown and described. In one example the rotating clinching clasp is part of a removable securement system for at least two items. The system includes at least one rotating clinching clasp. The rotating clinching clasp has a head with a shank protruding therefrom. The shank has an undercut located between the head and the guide end. The system further includes a first item having a top surface. The at least one rotating clinching clasp is secured within and protrudes from the top surface of the first item. The system includes a second item having at least one aperture therein. The second item is placed against the top surface of the first item and is removably held in place by the head of the at least one clinching clasp when the head is rotated from a first position to a second position.

### CROSS REFERENCE TO RELATED APPLICATIONS

This application claims the benefit of U.S. Provisional Application No. 63/350,570 filed on Jun. 9, 2022. The above identified patent application is herein incorporated by reference in its entirety to provide continuity of disclosure.

### BACKGROUND OF THE INVENTION

The present invention relates to clinching clasps. More particularly, the present invention provides a rotating clinching clasp which overcomes a multitude of problems found in the prior art of securing devices.

A clinching pin has previously been used in an effort to hold one panel to another for some time. However, there are serious drawbacks to using such a device for securing items together. One option when it comes to securing components together is a screw device of some sort. Regardless of the type or method there are drawbacks in using screws. The first of which is often times when such a securement device is used, such as the one described herein, the components are extremely small. For example, often times these securement devices are using in mobile phones or computers. The current trend of reducing size and weight is leading to thinner and thinner devices.

The reduction in size of the device and the size of the components themselves leads to several potential complications. Primarily, the heads required on any screw device would potentially be large enough to hinder other components or the full assembly in a device. In many cases the heads of screws will sit about the panel to be secured. In other instances, the head of a screw must be significantly wide enough to allow for a driver to be placed therein.

The use of screws may also cause various additional complications. For example, it is possible that screws may come loose over time. This means that a screw may need a chemical thread locker. This thread locker may also fail or could result in the screw being incapable of being removed. Further, if another common solution were employed, the use of nylon locks, the screws may become stripped. Many nylon patches which are using in such a process exceed the stripping strength of the mating threads, which are typically aluminum.

Another issue with screws in the current environment is the minimal depth of the mating threads and screw hole. In order to meet with the demand for a thin device screw holes are also kept at a minimum. This means that the screws will also have a short thread length. This short thread length often leads to weak threads that are easily stripped.

A solution to the issues presented in using screws, is to use a clinching fastener. These fasteners are traditionally pressed through an aperture in the panel to be secure to the device. The fasteners are then pressed into a plate, which is softer than the fastener. The softer material of the installation panel flows into the undercut of the hard clinching fastener securing it in place. While these fasteners solve several of the problems with screws, they present an entirely new set of problems.

Clinching fasteners are permanently installed. This means that once they are installed, the device cannot be disassembled without damaging the device. Many countries have begun enacting laws for the right to repair. Meaning that some clinching fasteners in applications where repairability is mandated, will face obsolescence due to the inability to remove and reuse them. When a clinching fastener is pulled from the hole that it was installed into, the installation hole itself is damaged and rendered useless, making repairability to the original state impossible.

Another drawback to using clinching fasteners is how and when they are installed. Typically, clinching fasteners are installed by being pressed into a material. In many cases this material is anodized aluminum. The process of pushing the clinching fasteners into the anodized aluminum could cause cracking or destruction of the aluminum.

Consequently, there is a need for an improvement in the art of removably securing items together. The present invention substantially diverges in design elements from the known art while at the same time solves a problem many people face when attempting to removably secure panels together. In this regard the present invention substantially fulfills these needs.

### SUMMARY OF THE INVENTION

The present invention provides a rotating clinching clasp wherein the same can be utilized for providing convenience when a user needs to assemble, for example an electronic device, and have the ability to disassemble the same. The rotating clinching clasp includes a head having a shank protruding form a bottom side thereof. The shank has a guide end, wherein the guide end is opposite the connection to the head. The shank has a shoulder portion directly adjacent to the head connection. Wherein the shoulder portion creates and under cut in the shank. The clinching clasp shall be rotatable when installed.

Another objective of the rotating clinching clasp if to have the head be rectangular.

Another objective of the rotating clinching clasp if to have the bottom of the head has an angle created by the thickness of the head; wherein the head is thicker adjacent to the shank and thinner at the end.

Another objective of the rotating clinching clasp if to have a detent protruding beneath the head adjacent to the shank.

Another objective of the rotating clinching clasp if to have a cavity locating in the top of the head.

Another objective of the rotating clinching clasp if to have the shank be smooth.

Another objective of the present invention is for the rotating clinching clasp to be included within a securement system for removably securing at least two items together includes At least one rotating clinching clasp. The rotating clinching clasp is including those items as described in the objectives above. A first item having a top surface wherein at least one rotating clinching clasp is secured within and protrudes from the top surface of the first item. A second item having at least one aperture therein. The second item is placed against the top surface of the first item and is removably held in place by the head of the at least one clinching clasp.

Another objective of the securement system for removably securing at least two items together is to have the head of the at least one clinching clasp has length that is greater Another objective of the securement system for removably securing at least two items together is to have the aperture of the second items has a length that is greater than the width.

Another objective of the securement system for removably securing at least two items together is to have the first item is secured to the second item when the rotating latch Another objective of the securement system for removably securing at least two items together is that when the at least one clinching clasp rotated from a first position to a second position the head engages the wings of the at least one aperture.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of a rotating clinching clasp.

FIG. 2 shows top-down view of an embodiment of a rotating clinching clasp.

FIG. 3 shows a side view of an embodiment of a rotating clinching clasp engaged in a first material.

FIG. 4 shows a perspective view of an embodiment of a rotating clinching clasp.

FIG. 5 shows a side view of an embodiment of a rotating clinching clasp engaged in a first material.

FIG. 6 shows a perspective view of an embodiment of a plurality of rotating clinching clasps secured in a first material and a first plate to be secured thereto.

FIG. 7 shows a perspective view of an embodiment of a plurality of rotating clinching clasps secured in a first material securing a first plate thereto.

FIG. 8A shows a perspective view of an embodiment of a plate to be secured by the rotating clinching clasp.

FIG. 8B shows a perspective view of an embodiment of a plate to be secured by the rotating clinching clasp.

FIG. 9 shows a side cross-sectional view of an embodiment of at least one rotating clinching clasp securing a plate to a first material.

FIG. 10A shows a perspective view of an embodiment of at least one rotating clinching clasp securing a plate to a first material.

FIG. 10B shows a cross-sectional view of an embodiment of at least one rotating clinching clasp securing a plate to a first material.

FIG. 11 shows a perspective view of an embodiment of a tool for turning the rotating clinching clasp.

FIG. 12 shows a bottom-up view of an embodiment of a tool for turning the rotating clinching clasp.

### DETAILED DESCRIPTION OF THE INVENTION

Reference is made herein to the attached drawings. Like reference numerals are used throughout the drawings to depict like or similar elements of the rotating clinching clasp. For the purposes of presenting a brief and clear description of the present invention, a preferred embodiment will be discussed as used for the rotating clinching clasp. The figures are intended for representative purposes only and should not be considered to be limiting in any respect.

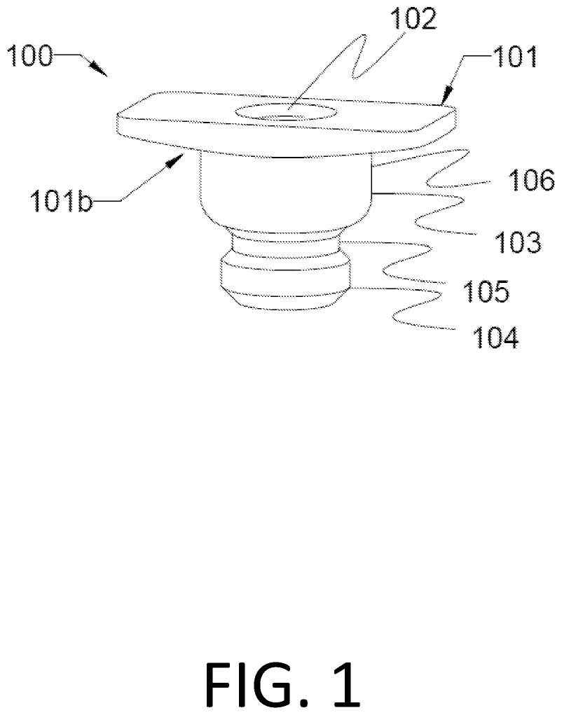

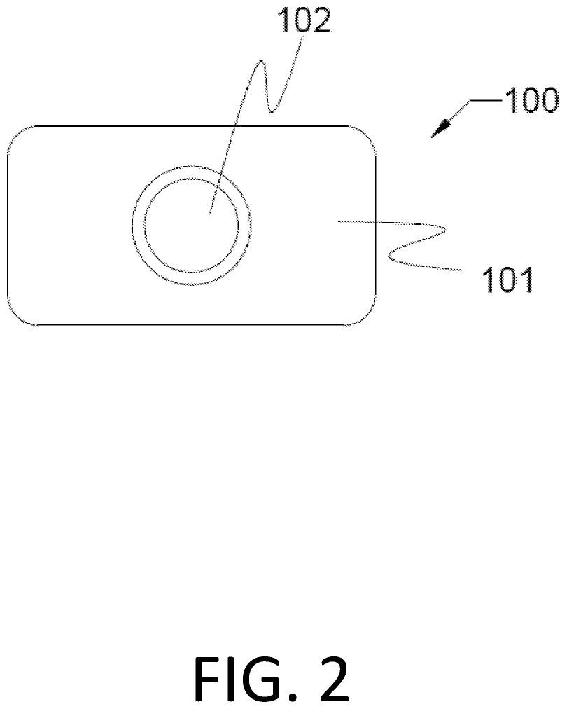

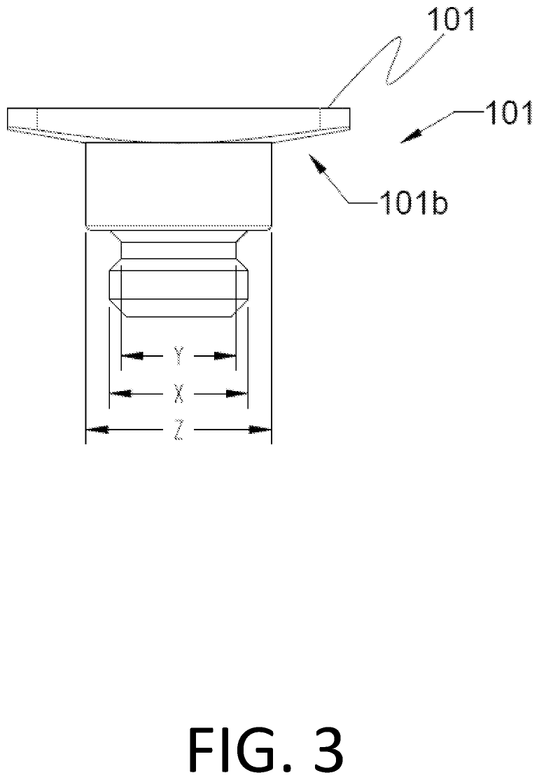

Referring now to FIG. 1, FIG. 2, and FIG. 3, there is shown several views of embodiments of a rotating clinching clasp. The rotating clinching clasp 100 is comprised of a head 101. The head 101 is shaped such that the length is greater than the width. In one embodiment the head 101 is rectangular. In another embodiment the head 101 is oval shaped. In the embodiments of FIG. 1 and FIG. 2 the head 101 is tapered along the length. In these embodiments the taper is thickest at the middle of the length of the head 101 and narrowest at the edges. In the embodiment of FIG. 3 the head 101 is not tapered but of a uniform thickness.

In one embodiment the head 101 has a cavity 102 located through the top side 101a of the head 101. In one embodiment the cavity 102 is cylindrical. In another embodiment the cavity 102 is of another geometric shape. In the shown embodiment the cavity 102 is located approximately in the center of the head 101. The cavity 102 will be used to operate the rotational clinching clasp 100 as described below.

The rotational clinching clasp is further comprised of a shank 103 which protrudes from the bottom side 101b of the head 101. The shank 103 is substantially round. Further in many embodiments the shank 103 is substantially smooth. The shank 103 is comprised of several elements.

At the end of the shank 103 opposite the connection to the head 101 the shank 103 includes a guide portion 104. The guide portion 104 is of a first diameter X. In different embodiments the guide portion 104 may include at least one tapered edge. In these embodiments the taper will be less than the first diameter X. The shank 103 further includes an undercut 105. The undercut 105 is located above the guide portion 104. The undercut 105 of has a second diameter Y. In one embodiment the undercut 105 may taper down to reach the second diameter Y.

The shank 103 further includes a barrel portion 106. The barrel portion 106 has a third diameter Z. The third diameter is greater than that of the first diameter X and the second diameter Y. In one embodiment the barrel portion 106 has a taper. In this embodiment the barrel portion 106 will have at least a diameter of the third diameter Z. The barrel portion 106 will directly connect to the head 101 of the rotating clinching clasp 100.

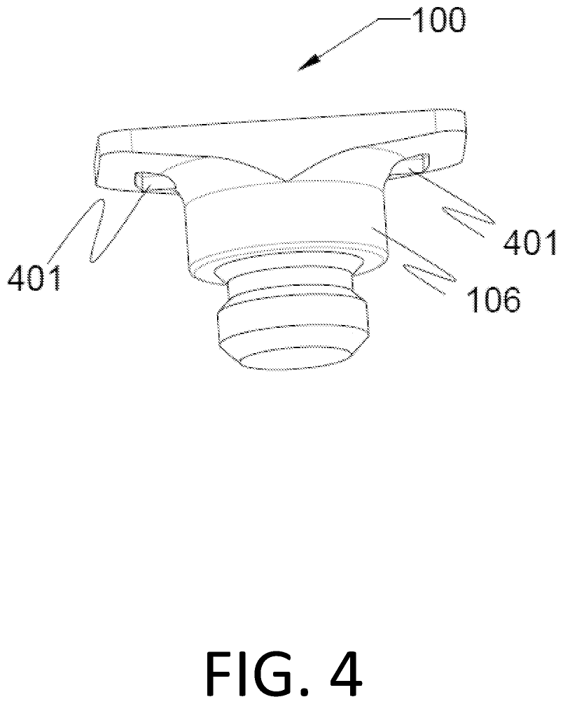

Referring now to FIG. 4, there is shown a perspective view of an embodiment of a rotating clinching clasp. In one embodiment the rotating clinching clasp 100 includes at least one additional element. In one embodiment the rotating clinching clasp 100 further includes at least one detent 401. In the shown embodiment the at least one detent 401 is connected to the head 101 of the of the rotating clinching clasp 100. Further, in the shown embodiment the at least one detent 401 is located such that it is directly adjacent to the barrel portion 106. In various embodiments the at least one detent 401 will secure the clinching clasp at a position not aligned to the rectangular hole orientation. In one embodiment the clinching clasp will be secured at a position 90 degrees in orientation to the rectangular hole.

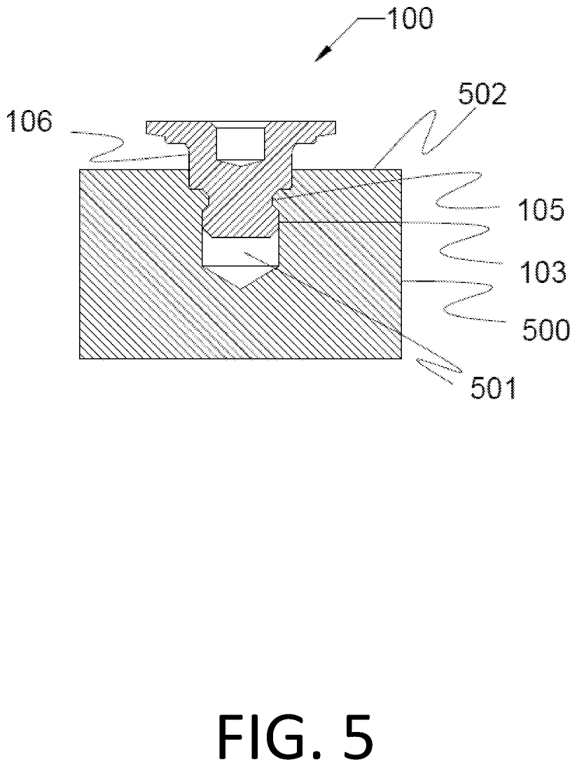

Referring now to FIG. 5, there is shown a side view of an embodiment of a rotating clinching clasp engaged in a first material. In the shown FIG. a rotating clinching clasp 100 has been engaged within a first material 500. In on embodiment the first material is an aluminum material. In other embodiments the first material 500 may be another material. However, the first material 500 should have a hardness that is less than that of the material used to create the rotating clinching clasp 100.

When a rotating clinching clasp 100 is used, the guide portion 103 is inserted into a hole 501 located in the first material 500. The hole 501 will have a diameter which is greater than diameter X but less than diameter Z. The barrel 106 of the rotating clinching clasp 100 will sit upon the surface 502 of the first material 500. The rotating clinching clasp 100 is then pressed into the first material 500. The barrel 106 of the rotating clinching clasp 100 will be seated at least partially within the first material 500. Once the rotating clinching clasp 100 is seated within the first material 500 will be deformed and part of the first material 500 will be forced into the undercut 105 of the rotating clinching clasp 100. Once seated within the rotating clinching clasp 100 will be rotatably secured within the first material.

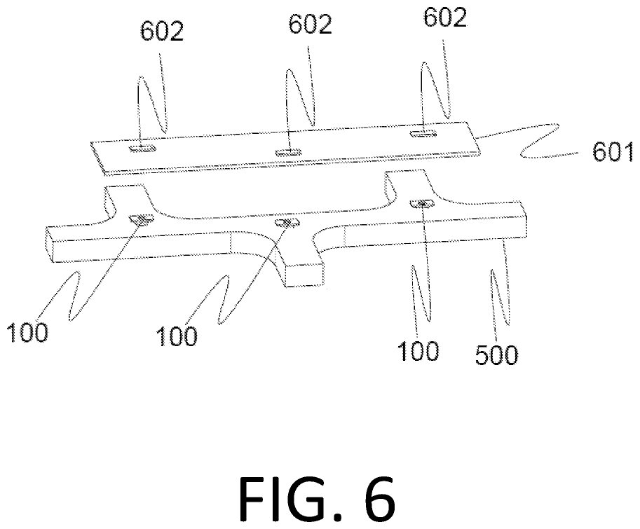

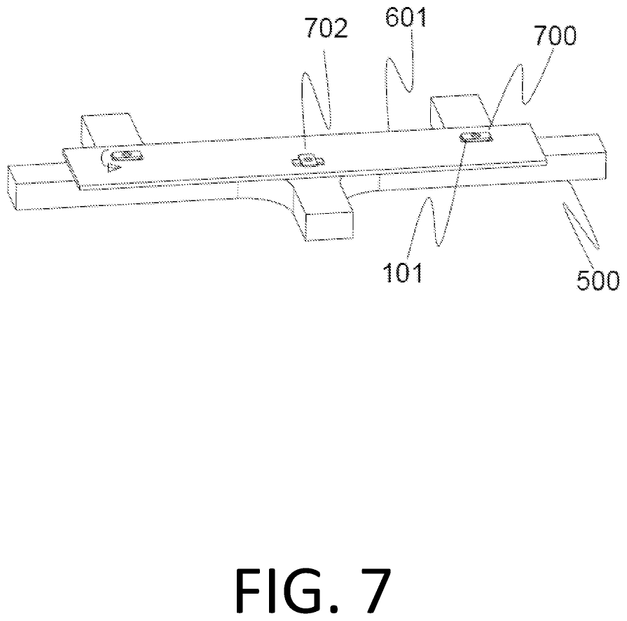

Referring now to FIG. 6 and FIG. 7, there is shown perspectives view of an embodiment of a plurality of rotating clinching clasps secured in a first material which are used to secure a first plate thereto. The shown embodiment is a general FIG. for the understanding of how the rotating clinching clasp 100 or a plurality of rotating clinching clasps 100 and used to secure a plate 601 to a first material 500. The rotating clinching clasp(s) 500 will be able to be used in all manner of plate securement operations and necessary devices.

In the shown embodiment three rotating clinching clasps 100 are secured within the first material 500 as shown and described in FIG. 5. The first plate 601 has a plurality of apertures 602 therethrough. The plurality of apertures numbers in at least the same amount as the number of rotating clinching clasps 100 which are used to secure the first plate 601. The apertures 602 must have a length and width greater than that of the head 101 of the rotating clinching clasp 100. However, the width of the apparatus 601 should be less than that of the length of the head 101 of the rotating clinching clasp 100. The apertures 602 should align with the rotating clinching clasps 100.

In use, once the rotating clinching clasp(s) 100 have been secured within the first material 500, the first plate 601 is placed thereon. The heads 100 of the rotating clinching clasps 100 shall protrude through the apertures 602 of the first plate 601. A tool as described below is then used to rotate the heads 101 of the rotating clinching clasps 100 from a first position 701 to a second position 702. In one embodiment the second position is approximately 90 degrees of rotation from the first position. In other embodiments different degrees of rotation may be used for example 45 degrees of rotation may be used. Once the rotating clinching clasps 100 are in the second position the length of the heads 101 will overlap the surface of the first plate 601. This will secure the first plate 601 to the first material 500.

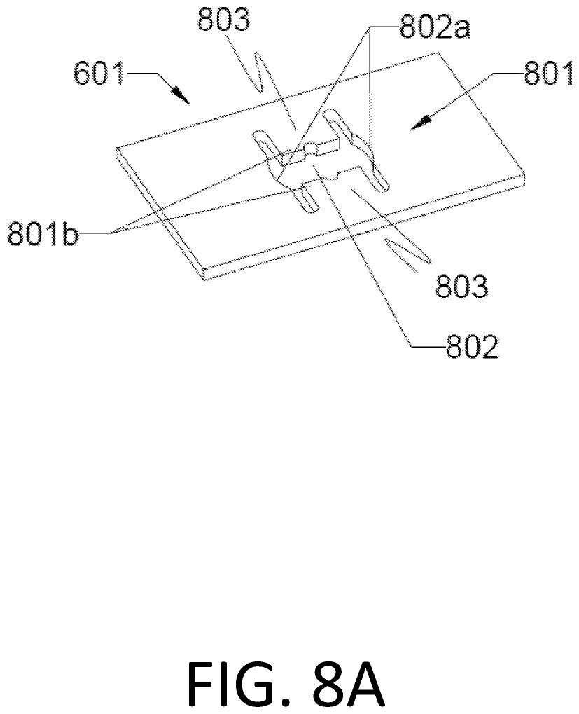

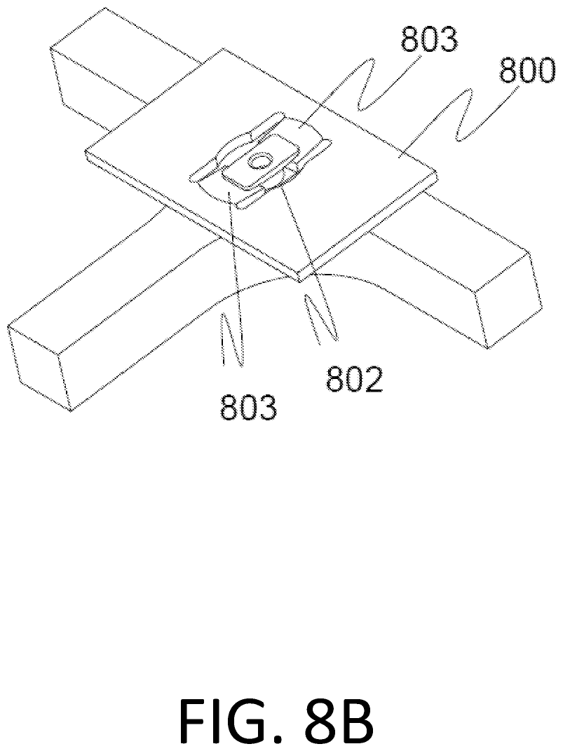

Referring now to FIG. 8A and FIG. 8B, there is shown perspective views of an embodiment of a plate to be secured by the rotating clinching clasp. In some embodiments when the rotating clinching clasp is moved from a first position to a second position a clamp load is created by deflecting structures on the attaching plate. In another embodiment the clamp load is applied due to the contact between the taper of the underside of the head of the rotating clinching clasp and deflecting features on the attaching panel. As the head is rotated from the first position to the second position the taper will engage the first plate. The deflected features on the first plate press upward against the tapered bottom surface of the tack, causing a reaction clamp load between the first and second panels. It is important to ensure that the force of the clamp load created will not exceed the pullout force of the rotating clinching clasp installed in the first material.

In yet a further embodiment the apertures of the first plate 601 are specially formed to apply clamp load to secure the first plate when the rotating clinching clasp is moved from the first position to the second position. In the shown embodiment the aperture 801 has a center opening 802. The center opening 802 has a length 801a greater than that of the head of the desired rotating clinching clasp. The opening further includes at least one wing 803. In the shown embodiment there are two wings 803, one located on either side of the aperture 801. The edge of the at least one wing and the opposing side of either a second wing 803 or the side of the aperture 801 will create the width 801b of the center opening 802. The width 801b should be wider than the width of the head of the rotating clinching clasp but less than the length of the head of the rotating clinching clasp.

In different embodiments, the at least one wing 803 may have different features. However, in many embodiments when the rotating clinching clasp is moved from the first position to the second position a clamp load will be created due to the deformation of the wings 803. In one embodiment the wings 803 are on the same plane as the rest of the fist plate. However, in a further embodiment the wings 803 are angled away from the plane of the first plate. In the shown embodiment the wings 803 are angled in an upward direction. When the rotating clinching clasp is rotated to the second position the wings 803 are forced down and beneath the head of the rotating clinching clasp.

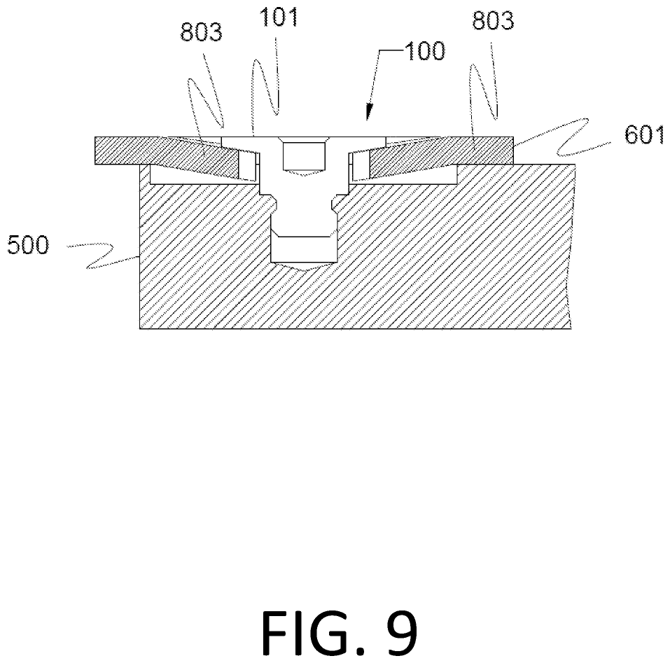

Referring now to FIG. 9, there is shown a side cross-sectional view of an embodiment of at least one rotating clinching clasp securing a plate to a first material. In the shown embodiment the rotating clinching clasp 100 has been rotated into the second position. The head 101 of the clinching clasp 100 has engaged a pair of wings 803 of the first plate 601. It can be seen from this view that the wings have been leveraged into a position below the plan of the first plate 601. In the shown embodiment when the head 101 of the rotating clinching clasp 100 is tapered. In one embodiment when the head 101 is engaged with the wings 803 the wings 803 are pushed into a position such that they are flush with the taper of the rotating clinching clasp 100.

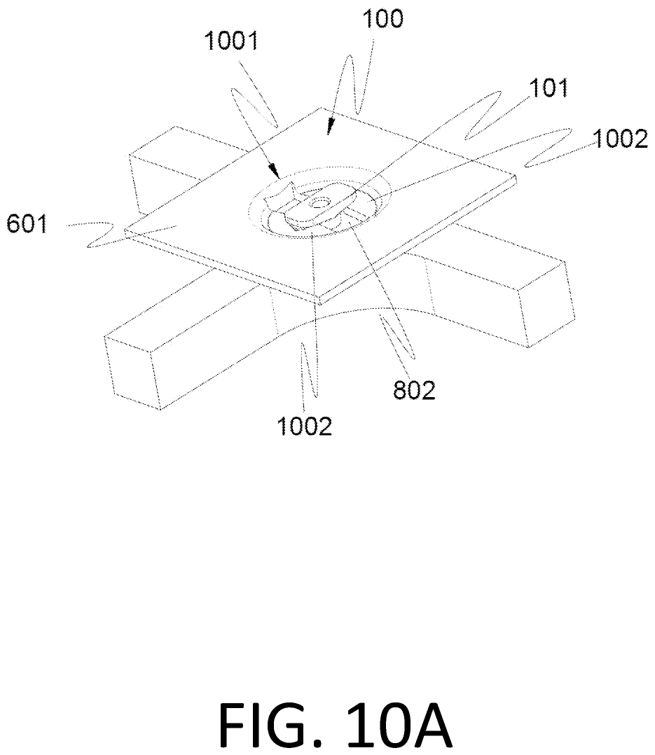

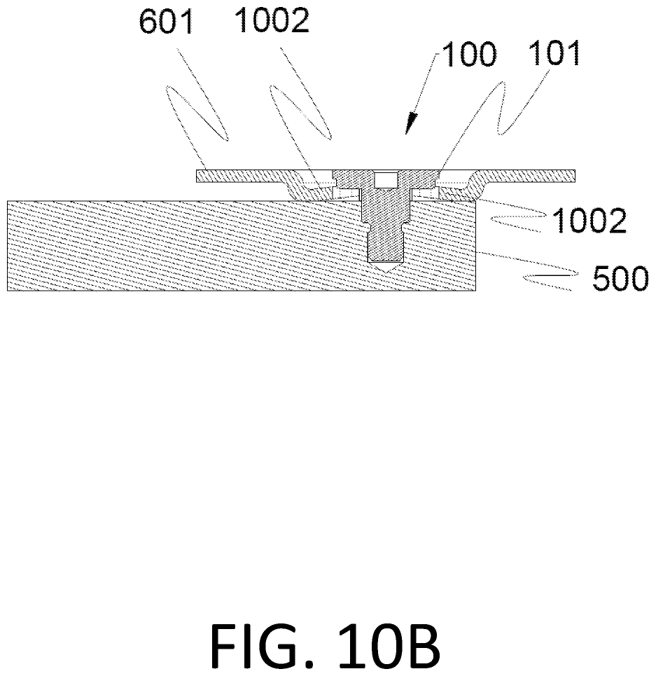

In order to allow for this final position of the wings 803 the first material 500 has a cutout which surrounds the rotating clinching clasp 100. This cutout space can also be created with the addition of a gasket or riser to the first material. In the call out of FIG. 10, the wings 803 can be seen, in a starting position, flush with the surface of the first plate 601. In this way the rotating clinching clasp 100 has removably secured the first plate 601 to the first material 500. Further, in this manner the design of the wings 803 and the engagement of the head 101 of the rotating clinching clasp 100 have created a clamp load ensuring the rotating clinching clasp does not rotate from the second, secured position.

Referring now to FIG. 10A and FIG. 10B, there is shown a several views of an embodiment of at least one rotating clinching clasp securing a plate to a first material. In the shown embodiment the rotating clinching clasp 100 has been rotated into the second position. In this embodiment instead of wings, which are configured to engage the rotating clinching clasp 100, the plate is specially designed indent 1001. This indent 1001 still includes the center opening 801. However, the wings are replaced with adjacent surfaces 1002. In one embodiment the side surfaces 1002 are bowed. This bow will create clamp load when the rotating clinching clasp 100 is rotated into the second position.

In the cross sectional view the side surfaces can be seen in this bowed configuration. In one embodiment the indent 1001 may fit into an opening of the first material 500 which secure the plate 601 to a first material 500. This will allow for the connection of the plate to the first material to be even thinner than without the opening. Further, while not seen in these FIGs. in one embodiment the head 101 of the rotating clinching clasp 100 still includes detents. The detents will contact the side surfaces 1002 ensuring the rotating clinching clasp 100 stays secured in the second position.

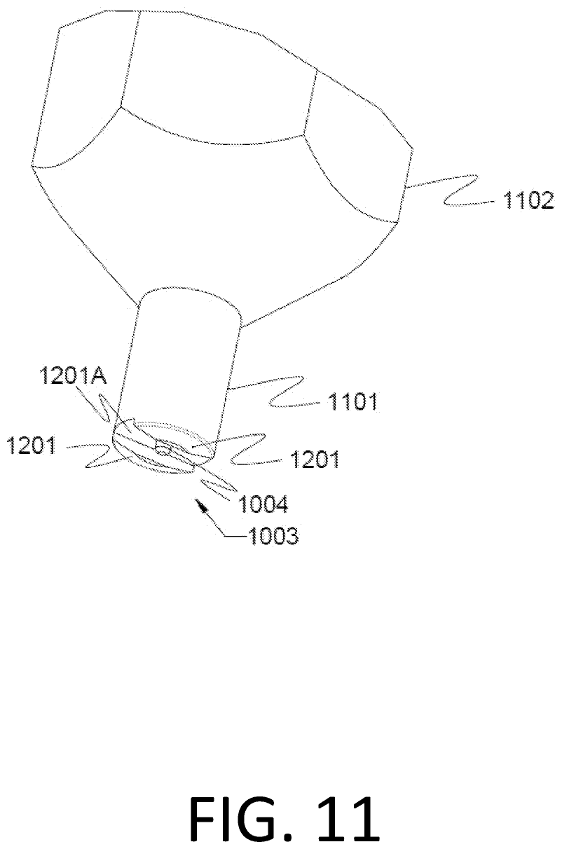

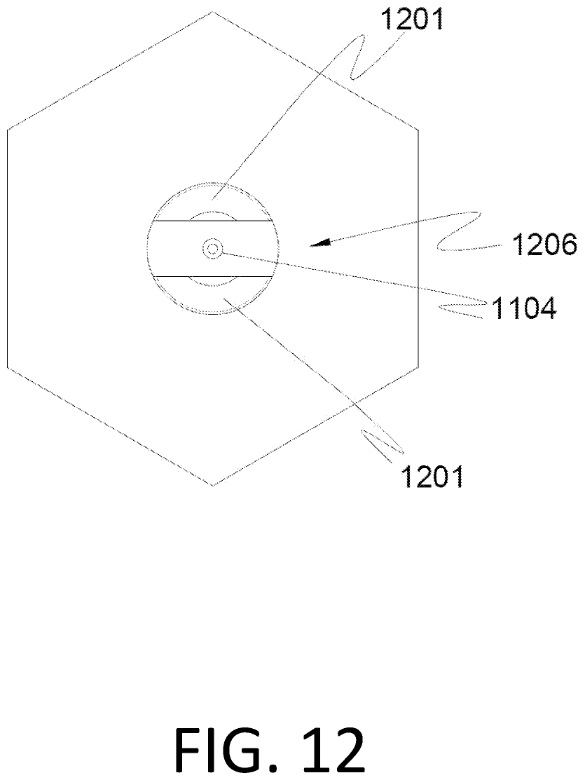

Referring now to FIG. 11, there is shown a perspective view of an embodiment of a tool for turning the rotating clinching clasp and FIG. 12 there is shown a bottom-up view of an embodiment of a tool for turning the rotating clinching clasp. In some embodiments the rotational clinching clasps will be of a size where traditional tools will be too large to operate the tacks. This is due to the size of the tacks; in some embodiments the heads of rotational clinching clasps may only be a millimeter or less. Here in is now described several embodiments for a tool that will enable proper operating of rotational clinching clasps of any size. The tool shall include a shank portion 1101. In one embodiment the shank portion 1101 doubles as a handle for the tool. In the embodiment where the shank portion operates as a handle 1102 for the tool, the shank portion 1101 may taper down to be narrower at one end. In another embodiment the shank portion 1101 enables the tool to be connected to a tool rotating tool head 1103 or other device. At one end of the tool is the tool head 1103. In the shown embodiment the tool head 1103 include a plurality of prongs. In one embodiment a middle prong is design to enter the cavity of the head of the rotational clinching clasp. The other prongs will engage the edge portions of the head of a rotational clinching clasp. The tool may then be turned to rotate the rotational clinching clasp from the first position to a second position.

In some embodiments the rotational clinching clasps will be of a size that is only a few millimeters. When the rotational clinching clasps are of this size the prongs of the tool would need to be equally small. At these dimensions the prongs may not be strong enough to turn the rotational clinching clasps. They may also be susceptible to damage overtime.

A modification to the tool is presented to account for this situation. In the shown embodiment the tool for operating the rotational clinching clasps still includes a shank portion 1101. In this embodiment just like that of the one described about the shank portion 1101 may be used as a handle. Further just like that of the embodiment described above the shank portion 1101 may taper down to a necessary size.

Further, just like that of the embodiment described above the tool will include a middle prong 1004 for engaging with the head of the rotational clinching clasp. Here the outer prongs are replaced. The outer prongs are replaced with a set of walls 1201. The set of walls 1201 will create a channel 1201a. The channel 1201a will allow the head of the rotation clinching clasp to be engaged and turned to the desired position. The use of side walls 1201 instead of prongs will allow for additional strength of the tool head.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A rotating clinch clasp, the clasp comprising:
a head having a shank protruding from a bottom side thereof;
the shank having a guide end, wherein the guide end is opposite the the head;
the shank has an undercut located between the head and the guide end;
wherein the undercut encircles the entire shank; and
wherein the undercut is forcibly filled with a second material when the clasp is inserted into the second material for use;
the clinch clasp shall be rotatable when installed in the second material.

2) The rotating clinch clasp of claim 1, wherein the head is rectangular.

3) The rotating clinch clasp of claim 1, wherein the bottom of the head has an angle created by the thickness of the head; wherein the head is thicker adjacent to the shank and thinner at the end.

4) The rotating clinch clasp of claim 1, further comprising a detent protruding beneath the head adjacent to the shank.

5) The rotating clinch clasp of claim 1, further comprising a cavity locating in the top of the head.

6) The rotating clinch clasp of claim 1, wherein an exterior surface of the shank is smooth, thus allowing the clasp to rotate.

7) A securement system for removably securing at least two items together, the system comprising:
at least one rotating clinch clasp;
the rotating clinch clasp is comprised of
a head having a shank protruding from a bottom side thereof;
the shank having a guide end, wherein the guide end is opposite the the head;
the shank has an undercut located between the head and the guide end;
wherein the undercut encircles the entire shank;
a first item, made of a second material, having a top surface; wherein at least one rotating clinch clasp is secured within and protrudes from the top surface of the first item;
wherein the undercut of the clasp is forcibly filled with the second material when the clasp is secured into the first item for use; and
the clinch clasp shall be rotatable when installed in the second material;
a second item having at least one aperture therein;
the second item is placed against the top surface of the first item and is removably held in place by the head of the at least one clinch clasp.

8) The securement system for removably securing at least two items together of claim 8, wherein the head of the at least one clinch clasp has length that is greater than the width.

9) The securement system for removably securing at least two items together of claim 8, wherein the aperture of the second items has a length that is greater than the width.

10) The securement system for removably securing at least two items together of claim 8, wherein the first item is secured to the second item when the rotating clinch clasp is rotated from a first position to a second position.

11) The securement system for removably securing at least two items together of claim 8,
wherein the head of the at least one clinch clasp has length that is greater than the width;
wherein the aperture of the second items has a length that is greater than the width;
wherein the first item is secured to the second item when the rotating clinch clasp is rotated from a first position to a second position.

12) The securement system for removably securing at least two items together of claim 8 wherein the at least one aperture is comprised of a pair of wings; one located on opposite sides of the aperture.

13) The securement system for removably securing at least two items together of claim 12, wherein when the at least one clinch clasp is rotated from a first position to a second position the head engages the wings of the at least one aperture.

14) The rotating clinch clasp of claim 3, wherein the angle of the head creates an even taper from the shank to end of the head.

15) The rotating clinch clasp of claim 5, wherein the cavity in the head has a cylindrical cross section.

16) The rotating clinch clasp of claim 15, wherein the shape of the head and the cavity allow a specialized tool to be used to rotate the clasp from exterior edges of the head.
